(19) United States
(12) Patent Application Publication
(10) Pub. No.: US 2005/0158439 A1
(43) Pub. Date: Jul. 21, 2005

(54) Non-sheeted freezer-to-oven dough with a simplified leavening system

(76) Inventors: Dave Zhang, Portage, MI (US); Xiaoming You, Clarence Center, NY (US)

Correspondence Address: HODGSON RUSS LLP, ONE M & T PLAZA, SUITE 2000, BUFFALO, NY, 14203-2391, US

(21) Appl. No.: 10/996,686

(22) Filed: Nov. 24, 2004

Related U.S. Application Data
(60) Provisional application No. 60/525,406, filed on Nov. 26, 2003.

(51) Int. Cl. A21D 2/00

(52) U.S. Cl. 426/551

(57) ABSTRACT

A non-sheeted, non-laminated freezer to oven dough is provided comprising flour, water, a chemical leavening system with soda present in an amount of about 0.4% to about 1.5% by weight (as compared to the amount of flour) and an acid ingredient (SALP), and from about 3% to about 6% by weight of yeast, where the frozen dough does not require proofing. Preferably, the dough is shaped into the form of a square or a round shape, or molded into dinner rolls, rolled breadsticks or breads and the like. The dough may contain additional ingredients. The dough may be mixed with fruits/nuts, or with savory ingredients, or topped with one or more toppings, or smeared with a layer of a paste and rolled and cut into a swirl. Also provided is a method of making frozen dough and methods of making baked products which do not require proofing the dough.

### FIELD OF THE INVENTION

The present invention relates generally to the field of frozen doughs and more particularly to a non-sheeted, non-laminated freezer to oven dough that does not require proofing. The present invention also relates to methods of making frozen dough. The present invention further relates to methods of making a baked product that includes removing the frozen dough from a freezer and transferring the dough to an oven for baking.

### BACKGROUND OF THE INVENTION

Freshly-baked products are generally preferred by consumers because of their “fresh” taste and aroma. However, traditional way of preparing freshly baked products is time-consuming. A step that requires a significant amount of time is proofing—during which yeast produces carbon dioxide that expands the product during baking. Proofing needs a proofer with temperature and humidity control, experienced personnel, and is time consuming (usually >1 hr).

Frozen doughs have been described that do not need a proofing step, but the leavening agents are either very high in level (2.5-4.0%, U.S. Pat. No. 5,451,417), or more than one acid is required (step-wise leavening, WO 01/32023 A1). The former produces a product having biscuit-like taste and texture, and the latter results in a loss of leavening system's gassing power during storage of the frozen doughs.

### SUMMARY OF THE INVENTION

The present invention provides frozen, non-sheeted, non-laminated dough that does not need to be proofed prior to baking. In particular, this freezer-to-oven dough contains a simplified leavening system with a leavening acid that does not release any significant amount of gas (CO₂) at freezer temperatures (generally lower than 20° F.) and one base (such as sodium bicarbonate, at a level of 0.4-1.5%, based on flour). By no release of appreciable gas at freezer temperatures is meant that for 100 gm of dough, less than 10 ml of CO₂ is released. In a preferred embodiment, less than 5% CO₂ is released and for a more preferred embodiment, for 100 gm of dough, less than 1% CO₂ is released. In one embodiment, the leavening acid is sodium aluminum phosphate (SALP). The frozen, non-sheeted, non-laminated dough of the present invention can be baked into a specific volume of 3.5-4.0 cc/g with a good taste and aroma.

The non-sheeted, non-laminated dough using a chemical leavening system with one leavening acid (SALP) and one base (sodium bicarbonate, at a low level of 0.4-1.5%, based on flour) can be transferred directly from freezer to oven without proofing and baked into a product with good texture, flavor, and aroma.

The frozen dough of the present invention can be made into a variety of non-sheeted products including, but not limited to, sweet rolls, cinnamon rolls, rolls with fruit/nuts inclusion, dinner rolls, breads, breadsticks, savory rolls, bagels, donuts, fritters, pretzels.

### DETAILED DESCRIPTION

The present invention will now be described in detail for specific preferred embodiments of the invention, it being understood that these embodiments are intended only as illustrative examples and the invention is not to be limited thereto.

The present invention provides non-sheeted, non-laminated freezer-to-oven dough products that can be baked from a frozen state, without thaw and proofing, to baked products with a good appearance and tasting. In sheeted doughs the gassing power of the acid ingredient does not appear to be particularly important since acids with different gassing power are disclosed to be useful (U.S. published patent application no. 2003/0049359 A1). The present invention is based on the unexpected finding that one acid (SALP) is particularly useful and sufficient for gassing function and also for conserving gassing power during frozen storage of non-sheeted dough products. Based on the findings disclosed herein, an efficient leavening system comprising one acid (sodium aluminum phosphate —SALP) and a low level of soda (such as sodium bicarbonate, 0.4-1.5%, flour basis) is provided for non-sheeted non-laminated doughs.

In the present invention, several acids (SAPP, GDL, and SALP) were compared in gassing power change in doughs during frozen storage. A Risograph was used to conduct the test. Doughs containing different leavening acids were placed in individual canisters stored in a freezer at a temperature of −11° F. The canisters were connected with tubing to a Risograph outside the freezer where the evolved carbon dioxide (if any) was recorded. As shown in Table 1, SAPP and GDL gradually released carbon dioxide and lost their gassing power during a frozen storage (48 hrs), whereas SALP did not.

TABLE 1
Carbon dioxide release (ml) from frozen dough using different leavening
acid stored at 11° F.

| | Leavening Acid | | |
|---|---|---|---|
| | GDL | SAPP28 | SALP |
| CO₂ Release (ml) | 53 | 33 | 0 |

Dough sample weight: 85 grams

While not intending to be bound by any particular theory, at freezing, there still exists free water which is not frozen. SAPP and GDL are thought to react with soda in free water to gradually lose gassing power. In contrast, it was found that SALP's reaction with soda is not triggered to any significant extent during freezing. and therefore, its gassing power is conserved during frozen storage. In fact, this discovery highlighted the drawback of using a fast acting acid in a FTO application as described in WO 01/32023 A1 (step-wise leavening,): losing gassing power in frozen storage. In the present invention, because there is no need to use fast-reacting acids (a waste of gassing power during freezing storage), and because the one acid (SALP) requires a very low soda level (0.4-1.5%), the one-acid (SALP) system virtually provides a substantial cost benefit compared to a high soda level system (2.5-4.0% soda, U.S. Pat. No. 5,451,417) or a multiple-acid system (WO 01/32023 A1, step-wise leavening).

The present invention is advantageous over other doughs known in the art of non-sheeted doughs in that the dough of the present invention does not require proofing (either before or after freezing the dough) and does not require thawing prior to transferring the dough to an oven. The dough has desirable properties such as flavor, texture, stability, etc. similar to those of known doughs. Moreover, the present invention does not require that the dough be transferred to an un-pre-heated oven that is subsequently heated to a temperature sufficient for baking the dough. Further, the baked products from the dough of the present invention is not biscuit-like in taste or flavor, but rather is similar to breads and rolls in texture and taste. Thus, the dough and methods of the present invention are advantageous in that they do not require the time, processing steps, equipment, space and labor that is required by methods and dough known in the non-sheeted dough art, and yet, it has an acceptable taste and texture.

The present invention relates to frozen non-sheeted dough that does not require proofing. The dough of the invention includes flour, water, the chemical leavening agent SALP, and from about 3% to about 6% by weight of yeast. According to the present invention the chemical leavening agent includes one soda ingredient and SALP, wherein the one soda ingredient is present in an amount of from about 0.4% to about 1.5% by weight.

All weights referred to herein, unless indicated otherwise, are by total weight of flour (taken as 100%) contained in the raw dough prior to baking. For example, a yeast weight percent of 3 is to be interpreted to mean that in a dough product in which 50 grams of flour are used, the yeast content is 2 grams. The phrases “on flour weight basis”, “based on the weight of flour” or “by weight of the flour” are used interchangeably and have the same meaning.

Soda ingredients are known to those skilled in the art, including for example, sodium bicarbonate, potassium bicarbonate, and the like and mixtures thereof. The soda ingredient is present in an amount of from about 0.4% to about 1.5%, preferably about 1.3%. Higher amounts of chemical leavening agent result in the dough having a biscuit-like quality, which is generally undesirable. A higher leavening level can also impart an undesirable flavor in baked goods. The ratio of soda ingredient to acid ingredient is preferably 1:1, at which the amount of leavening acid is such that the soda ingredient is completely neutralized. Therefore, the acid ingredient is also preferably present in an amount from about 0.4% to about 1.5%. The leavening agent (acid ingredient) is such that it does not exhibit any significant CO₂ release during freezing such as for example, sodium aluminum phosphate (SALP). Those skilled in the art will recognize that any leavening agent which does not release a significant amount of gas during freezing, but which is activated during oven baking temperatures can be used.

The frozen, non-sheeted, non-laminated dough of the present invention includes yeast. While not intending to be bound by any particular theory, it is considered that yeast is not the major leavening agent in the inventive dough, particularly, because the dough does not have to be proofed prior to baking. Rather, yeast is added in order to impart to a baked product prepared from the inventive dough, the flavor and aroma of a proofed baked product. This combination of yeast and chemical leavening achieves product quality with regard to taste, flavor and appearance. Traditional frozen dough for preparation of proofed products does not include chemical leavening at types and levels employed herein.

Yeast included in the inventive dough may be any type of suitable yeast known to those skilled in the art, including for example, yeast cream, compressed yeast, instant dry yeast, active dry yeast, protected active dry yeast, frozen yeast and combinations thereof. Preferred yeast according to the present invention is in the form of yeast cream.

The amount of yeast may be chosen to correspond to a desired flavor profile. Yeast amount also affects useable life of the dough. The yeast is preferably present in an amount of about 3% to about 6% by weight of the total amount of flour. Even more preferably, the yeast is present in an amount of about 4% by weight of the total amount of flour. While yeast percentages for cream yeast have been provided, the invention is in no way limited to compressed yeast. For a given quantity of cream yeast, one of ordinary skill in the art could easily determine equivalents thereof i.e., the quantity of another form of yeast having a different degree of hydration than cream yeast, but containing the same amount of yeast as the given quantity of compressed yeast. For example, the following general conversions are used in the art. One lb compressed yeast is generally equivalent to about 0.3125-4 lbs. instant yeast. Similarly, 1% compressed yeast is equivalent to about 1.5-1.8% cream yeast, which is equivalent to about 0.375-0.5% active dry, which is equivalent to about 0.3125-0.4% instant yeast.

The frozen non-sheeted, non-laminated dough according to the present invention further includes at least flour and water in effective amounts to prepare the dough.

The flour of the present invention may include one or more types of flour. Preferably, the flour includes at least 50% high gluten flour and 100% of the flour is Enriched Flour, i.e., flour that contains federally mandated amounts of flour, niacin, ferrous sulfate, riboflavin, enzyme, and thiamine mononitrate. The term “high gluten” as used herein means long patent flour made from high protein (i.e., greater than 10% protein). The flour of the present invention preferably has from about 10% to about 14% by weight protein, more preferably about 11% to about 13% by weight protein. High-protein flours are preferred because they provide the dough product with greater protein structure and/or quantity. Increased protein structure and/or quantity binds up water better within the dough product, maintaining and holding moisture within the product to yield longer shelf life. Additionally, enhanced protein characteristics provide better elasticity and expandability, which aid in holding gases generated due to yeast action and thus promote the raising of the dough.

Non-limiting examples of flours that may be included in the flour of the present invention include for example, enriched flour, bread flour, wheat flour, barley flour, rye flour, corn flour, potato flour and pastry flour. Bread flour has high absorption and good mixing tolerance.

The precise amount of water depends on the type of yeast included. Typically, from 40% to 80% of water is employed, preferably from 45% to 65%. Using less than 40% of water may result in poor processing (tearing/breaking) and/or in a dry baked product. Using more than 80% of water may result in excessively sticky dough and a gummy baked product.

The frozen dough of the present invention optionally contains one or more additional ingredients including for example, iron (preferably in the form of ferrous sulfate), salt, stabilizer(s), flavored oils, enzymes, sugar, niacin, at least one fat source, riboflavin, oil, corn meal, thiamine mononitrate, flavoring(s), and the like.

A non-limiting example of a stabilizer according to the present invention is a diacetyl tartaric acid ester of monoglyceride.

The dough may also include dough conditioners. Dough conditioners are typically non-specific oxidizing agents such as for example iodates, peroxides, ascorbic acid, K-bromate or azodi-carbonamide (ADA) and they are added to dough to improve the baking performance of flour to achieve a dough integrity and rheology which produces the desired final strength and texture. Commercially available conditioners include Tolerance Plus with or without ascorbic acid, and Panodan.

Enzymes according to the present invention may include for example amylases, in particular fungal amylase. Use of enzymes, such as amylases may be advantageous in that they may retard staling of the frozen dough or the resulting rolls, breads and the like. Enzymes may also result in an increased strength, improved extensibility or elasticity, stability and reduced stickiness of the dough, thus resulting in improved machinability during manufacture. The effect on the dough may be particularly advantageous when a poor quality flour is used. The improved machinability is of particular importance in connection with dough which is to be processed industrially. The amount and type of enzyme of the present invention may be determined by those skilled in the art depending on the specific desired resulting properties.

High-intensity sweetener, acesulfame-K, is used to provide sweetness and to avoid sugar's tenderizing effect, and thus improve baked product texture more like breads and rolls'. Acesulfame-K does not inhibit yeast's gassing performance. Other high-intensity sweeteners, such as sucralose, saccharin, aspartame, alitame, cyclamate, may be used for similar functions. Regular sugar can be used if a tender texture is needed for product attribute.

If sugar is used, a fine granulated sugar is preferred for use with embodiments of the invention formed from a pre-mix. Fine granulated sugars promote better mixing and consistency within the pre-mix. Fine granulated sugar, which is not as fine as powdered sugar but not as coarse as table sugar, is readily commercially available, as for example from the Domino Sugar Company.

A fine-blending salt is preferred to promote better mixing, for the same reasons that fine sugar is preferred. Salt may be added for desired flavoring; its hydrophilic properties are believed to help to control moisture content within the dough; and it also aids in controlling yeast activity. Fine-blending salt is readily available on the market, as for example from Cargill, Incorporated.

The dough of the invention preferably includes an effective amount of a fat source. The fat source contributes flavor and texture to the baked goods and may be liquid or semi-fluid as well as solid or plastic. The liquid fat is found to enhance products' baked shelf life (softness and moistness).

One example of a suitable fat source according to the present invention includes shortening. Shortening may be any oil or higher melting fat that is suitable for use in baked products. Glyceride shortenings derived from animal or vegetable fats and oils including synthetically prepared shortenings are suitable for use herein. The glyceride may contain saturated or unsaturated long chain acyl radicals having from about 12 to about 22 carbon atoms generally obtained from edible oils and fats such as corn oil, cottonseed oil, soybean oil, coconut oil, rapeseed oil, peanut oil, olive oil, palm oil, palm kernel oil, sunflower seed oil, wall flower oil, lard, tallow and the like. Examples of preferred shortenings according to the present invention, include vegetable shortenings, soybean based shortenings or oils, hydrogenated soybean-based shortening or oil, corn oil, palm oil, hydrogenated palm oil, lard and tallow oils. Butter and/or margarine may also be suitable as a shortening.

Any oil can be used, according to embodiments of the invention, but vegetable oil is preferred due to concerns about potential off flavors. Vegetable oil is preferably used to provide an extended baked shelf life (crumb softness). Vegetable oil lubricates the product to enhance its workability, and it promotes product tenderness. Vegetable oils that may be used in accordance with the present invention, include, but are not limited to soybean oil, cottonseed oil, peanut oil, canola oil, corn oil, olive oil and sunflower oil. Soybean and/or cottonseed oils are preferred. Certain oils, including sunflower and corn oils, potentially adversely affect the overall flavor profile of the dough and are therefore, less preferred.

The amount and type of fat source may be selected by those skilled in the art based on various factors including the ingredients of the frozen dough and/or toppings, and based on the desired taste and physical characteristics, such as maintaining a consistent internal structure.

Flavored oils may also be used in addition to or in place of the oil of the present invention. Non-limiting examples of flavored oils include olive, sesame, ginger and the like.

Flavorings according to the present invention may include, for example, oregano, basil, garlic, pepper, honey, sesame, cheese, cinnamon, wheat oats, peppers, onions, salsa based flavors, and tomatoes. Additionally, to achieve a desired flavor profile, a spray-dried encapsulated flavoring agent may be added to the dough. Spray-dried encapsulated flavorings are readily available on the market. Many different flavors can be used to achieve a desired effect, for example, yeast flavors.

When using flavorings, the amount of water and salt used in the dough may have to be adjusted to take into account, for example, the amount of salt and water already contained in the flavoring. It is believed that “fine tuning” of the amount of salt and water would be within the ability of one of ordinary skill in the art.

Baked color can be developed to suit final product needs via Millard reaction between reducing sugar and protein materials, addition of food-grade color compounds, etc.

When the frozen dough of the present invention is to be stored frozen for a substantial period of time, it is preferably wrapped in a moisture barrier. The wrapping may occur either before or after being frozen, preferably after freezing. Modified atmosphere packaging (MAP) can also be used.

Preferably, the dough is shaped into a desired shape prior to being frozen, such as, into the form of a square, or round, or rolled into dinner rolls, rolled breadsticks, or breads.

The dough rheology can be modified to suit different categories of baked products. In contrast to relatively dense products like sheeted pizza dough and bread sticks (about 2 cc/g), the present non-sheeted dough can expand to 3.5-4.0 cc/g.

Preferably, the frozen dough of the present invention includes the following ingredients shown in Table 2:

TABLE 2

| | |
|---|---|
| flour | |
| water | 45% to 70% |
| chemical leavening agent (SALP) | 0.4% to 1.5% |
| yeast | 2% to 4% |
| salt | 1% to 3% |
| stabilizer | 0.2% to 0.5% |
| acesulfame-K | 0.01% to 0.03% |
| vegetable shortening | 6% to 12% |

The frozen dough of this embodiment may include additional ingredients, such as iron, flavored oils, an enzyme, niacin, riboflavin, oil, corn meal, thiamine mononitrate, at least one flavoring, and the like.

An even more preferred embodiment of the present invention is a frozen non-sheeted dough that includes the following ingredients shown in Table 3:

TABLE 3

| high gluten flour/ | |
|---|---|
| Enriched Flour | |
| water | 68% |
| baking soda | 1.3% |
| sodium aluminum phosphate | 1.3% |
| yeast cream | 6% |
| whole egg powder | 2% |
| non-fat dry milk | 2% |
| salt | 1% |
| stabilizer | 0.2% |
| acesulfame-K | 0.02% |
| corn syrup | 4% |
| vegetable shortening | 9% |
| monoglycerides | 1% |
| ascorbic acid | 0.036% |
| amylase | 0.08% |
| calcium propionate | 0.2% |

The frozen dough of the above embodiments do not require proofing.

Method of Making Frozen Dough

The present invention also relates to a method of making frozen dough that includes combining the dough ingredients set forth herein, shaping and freezing the dough. These methods do not include proofing and the dough formed from these methods do not require proofing.

The type and relative amount of ingredients (including the required, preferred and optional ingredients) according to these methods are as set forth above with respect to the frozen dough of the present invention. In particular, according to the present invention, the ingredients include at least flour, water, chemical leavening agent including one soda ingredient and one acid ingredient, where the soda ingredient is present in an amount of 0.4% to 1.5%, and yeast in an amount of 3% to 6% by weight of the total amount of flour. Other preferred and optional ingredients and relative amounts of each ingredient according to the present methods are as set forth above with respect to the frozen dough.

The combining step may include either combining all of the ingredients at once or combining different combinations of ingredients first and then combining all of the ingredients together. For example, according to one embodiment, certain of the ingredients are combined to form a pre-mix, including for example, the chemical leavening agent, and optional salt, stabilizers and sugar. Then, the pre-mix is combined with the remaining ingredients including the flour, yeast, water and optional fat source. The pre-mix and/or the final mixture may include one or more additional ingredients as set forth herein.

According to a preferred embodiment of the present invention, the combining step includes forming a pre-mix of the chemical leavening agent, salt, stabilizer and sugar, and then the pre-mix is combined and mixed with flour, vegetable shortening, yeast cream and water. Even more preferably, the combining includes forming a pre-mix of salt, sodium aluminum phosphate, baking soda, ammonium sulfate, ascorbic acid, stabilizer, calcium sulfate, enriched flour, sugar, flour, niacin, ferrous sulfate, riboflavin, enzyme, and thiamine mononitrate, and then combining the pre-mix with high gluten flour, vegetable shortening, yeast cream and water.

Throughout the process of combining ingredients, ingredients may be mixed with one another by mixing methods generally known in the art.

In order to improve the aroma and flavor of the sheeted dough even further, according to an embodiment of the invention, yeast may be hydrated with warm water, allowed to ferment for about 10 minutes, and the resultant mixture is then added to the rest of the ingredients.

After combining the ingredients, they are then mixed (or further mixed if mixing steps have already taken place) by any suitable mixing apparatus, such as a Hobart mixer for example. The ingredients are mixed for about 2 to about 4 minutes on a first speed (low) and then for about 7 to about 19 minutes on a second speed (high), which is faster than the first speed. Preferably, the ingredients are mixed for about 2 minutes on low speed and for about 8 minutes on high speed. Then, yeast is added and mix for 1 min on low speed and 2 min on high speed. Mixing preferably takes place at a temperature of about 58° F. to about 64° F. In one embodiment, the chemical leavening agents and the yeast is added as late in the process as possible so that there is little opportunity for generation of gas. Thus, one component of the chemical leavening system (either the acid or the soda) may be added earlier in the process but the complementary agent is then added later in the process, such as just prior to shaping the dough.

Next, the dough is formed into a desired shape such as rolling dough into the form of dinner rolls or molding dough into the form of breads as known in the art.

The shaped dough is then frozen by methods known in the art. If the dough is going to be frozen for a short period of time, the mode of freezing is not critical. However, for prolonged stability, the dough should be frozen such that core temperatures of less than 30° F. and preferably between about 30° F. and about −13° F. are obtained within 1 to 6 hours and more preferably within about 1½ to about 4 hours of the time that the dough is placed in the freezing apparatus. When freezing the dough, a uniform cooling rate throughout the dough is desirable. The shaped dough is frozen, preferably by using spiral freezer (−29° F. to −61° F.). Carbon dioxide optionally may be used for gradual freezing (−0.4° F. to −10° F.).

For prolonged stability, the frozen dough is preferably stored at a temperature in a range of from about −42° F. to about −10° F., more preferably at a temperature in the range of from about −20° F. to about −12° F. Frozen dough according to the present invention may be stored for extended periods of time, i.e., at least about 12 weeks.

Optionally, the shaped dough is topped with at least one topping and/or flavoring prior to freezing the dough. Non-limiting examples of suitable toppings and flavorings that may be used in accordance with these methods, are as set forth above.

According to a preferred method herein, the process for preparing the dough of the present invention is as follows:
1) combining all dry ingredients except chemical leavening agents, mix for 1 min on low;
2) add liquid ingredients, shortening, yeast, mix on low about 2 to about 4 minutes and then mix on high for about 7 to about 9 minutes at a temperature of about 58°, to about 64° F.;
3) add leavening agents, mix on low for 1 minutes and then mix on high for about 2 minutes at a temperature of about 58° to about 64° F.;
4) shaping the dough into the form of rolls or breads or other shapes;
5) adding any toppings and/or flavorings; and
6) freezing the dough to a core temperature of less than 30° F.

The frozen dough made according to the present methods does not need to be thawed or proofed prior to baking. The dough may be taken directly from the freezer to the oven. The resulting baked product preferably substantially resembles a traditional proofed product in appearance, structure, and taste. Replacing the shortening with oil gives the baked product a softer and moister texture and enables the product to stay soft and moist for a longer time.

Methods Of Making FTO Frozen Dough Products

Further provided are methods of making dough products that include removing frozen dough of the present invention (made by the above-described methods or other methods that would be apparent to those skilled in the art), from a freezer and without proofing or thawing the dough, transferring the dough to an oven that is pre-heated to a temperature sufficient to bake the products.

Also provided are methods of making fruit rolls that includes removing frozen sheeted dough of the present invention (made by the above-described methods or other methods that would be apparent to those skilled in the art), which is shaped into the form of fruit rolls, from a freezer and without proofing or thawing the dough, transferring the dough to an oven that is pre-heated to a temperature sufficient to bake the fruit rolls.

The oven preferably is a thermostatically controlled oven. However, any oven known in the art that is suitable for baking may be used. Rack oven with steam application is preferred, and convection oven baking may need to place square shaped products into a cluster in a baking pan.

The dough of the present invention would be fully baked when its interior reaches a temperature of at least about 175° F. These interior temperatures are typically achieved by heating the product at a temperature in the range of from about 250° F. to about 500° F., more preferably from about 325° F. to about 450° F., for a corresponding period of time in the range of from about 10 to about 40 minutes, depending on the weight and shape of the baked product, as well as the type of oven used to bake the product.

In the methods of the present invention frozen dough is transferred to an oven without a proofing step. The oven is preferably pre-heated to a temperature sufficient to bake the dough prior to transferring the dough to the oven. For example, the oven may be pre-heated to a temperature of about 325° F. to about 425° F., preferably about 350° F., which cooks the dough after about 16 to about 22 minutes. Alternatively, the dough may be transferred to an oven that has not been pre-heated, or as only been partially pre-heated.

The exact conditions under which the dough is baked will depend upon the type of product, and will be apparent to one skilled in the art. For example, shapes having greater surface-to-volume ratios will cook faster than shapes having lesser surface-to-volume ratios.

Further provided by the present invention are fruit rolls made by the methods described herein. Preferably, the fruit rolls of the present invention are substantially similar in appearance, texture, structure, flavor, and aroma to fruit rolls, which use a dough that was proofed.

Instead of baking, the dough of the present invention can be cooked with steam resulting in a freezer to steamer product. Additionally, it can also be fried into different products such as breakfast items, snack items, etc.

The dough of the present invention can be formed in the shape of a swirl. In swirl product application, use of oil-based paste gives products a pleasant, golden brown, baked color due to oil-frying effect during baking. For water-based paste, water activity (Aw) matching between dough and paste is needed to minimize migration of ingredients between two components (dough and paste).

The present invention will now be described in detail with respect to showing how certain specific representative embodiments thereof may be made, apparatus and process steps being understood as examples that are intended to be illustrative only. In particular, the invention is not intended to be limited to the methods, ingredients, conditions, process parameters, apparatus and the like specifically recited herein.

### EXAMPLE 1

Dough is prepared from the following ingredients shown in Table 4:

TABLE 4

| INGREDIENTS | PERCENT BY WEIGHT |
|---|---|
| high gluten flour/ | |
| enriched Flour | |
| water | 68% |
| baking soda | 1.3% |
| sodium aluminum phosphate | 1.3% |
| yeast* | 4.77% |
| salt | 1% |
| xanthan gum | 0.2% |
| sugar | 6% |
| vegetable shortening | 9% |
| ascorbic acid | 0.036% |
| dried whole egg | 2% |
| non fat dried milk | 2% |
| corn syrup | 4% |
| monoglycerides | 1% |
| acesulfame-K | 0.02% |
| calcium propionate | 0.2% |
| Novomyl 1500 MG | 0.08% |
| dried raisin | 35% |
| cinnamon drops | 15% |

*Yeast Cream

All dry ingredients except leavening agents, acesulfame-K, raisins, and cinnamon drops are mixed together using a Hobart mixer, with a paddle on low speed for about 1 minute; add all wet ingredients (pre-dissolve acesulfame-K in water), mix for 2 minutes on low speed and for 8 minutes on high speed; add leavening agents, mix for 1 minutes on low speed and for 2 minutes on high speed; add raisins and cinnamon drops, mix for 1 minutes on low speed.

The ingredients are mixed as set forth therein. The dough can be rolled into the form of dinner rolls or molded into the form of breadsticks or breads as known in the art. Without proofing, the dough is frozen. After frozen storage, the dough is baked without thawing or proofing, at about 350° F. for 18-22 minutes.

### EXAMPLE 2

Dough (savory) is prepared from the following ingredients shown in Table 5:

TABLE 5

| INGREDIENTS | PERCENT BY WEIGHT |
|---|---|
| high gluten flour/ | |
| enriched Flour | |
| water | 68% |
| baking soda | 1.3% |
| sodium aluminum phosphate | 1.3% |
| yeast* | 4.77% |
| salt | 1.8% |
| xanthan gum | 0.2% |
| vegetable shortening | 9% |
| dried whole egg | 2% |
| non fat dried milk | 2% |
| corn syrup | 4% |
| monoglycerides | 1% |
| calcium propionate | 0.2% |
| Novomyl 1500 MG | 0.08% |
| parmesan cheese | 5% |
| Italian seasoning | 2% |
| onion powder | 1% |

*Yeast Cream

All dry ingredients except leavening agents, raisins, and cinnamon drops are mixed together using a Hobart mixer, with a paddle on low speed for about 1 minute; add all wet ingredients, mix for 2 minutes on low speed and for 8 minutes on high speed; add leavening agents, mix for 1 minutes on low speed and for 2 minutes on high speed.

The dough is then shaped, frozen and subsequently baked as in Example 1.

### EXAMPLE 3

Fruit ingredients can be added to the formulation of Example 1. The fruit ingredients can be a combination of dried fruits such as cherries, strawberries, blueberries, raspberries, pineapple, etc., nuts such as almonds, hazelnuts, pecans, etc., and/or chocolate chips. The dough is mixed as set forth therein. The mixture is then shaped into the form of rolls or breads and frozen. The frozen dough is then baked without thawing or proofing, at 350° F. for about 18-22 minutes.

### EXAMPLE 4

The savory ingredients from Example 2 can also be others such as cajun seasoning, jalapeno peppers, assorted red & green peppers, garlic, dried tomatoes, different cheeses, etc., or combination of these. The dough is mixed as set forth therein. The mixture is then shaped into the form of rolls or breads and frozen. The frozen dough is then baked without thawing or proofing, at 350° F. for about 18-22 minutes.

### EXAMPLE 5

The dough in Example 1 or Example 2 can be used as a sweet base dough or a savory base dough, respectively. In each case, the base dough can be sheeted and a flavor-compatible paste is smeared onto the sheeted dough. Then the dough plus paste layers are rolled and cut into a swirl. The base paste formula is shown in Table 6.

TABLE 6

| INGREDIENTS | PERCENT BY WEIGHT |
|---|---|
| extra fine powdered sugar | 36% |
| egg white powder | 4% |
| butter flavor | 2% |
| lethicin | 2% |
| vegetable shortening | 22% |
| soy oil or liquid oil | 22% |
| water | 12% |

All dry ingredients (powdered sugar, egg white, butter flavor, & lethicin) are mixed together using a Hobart mixer, with a wire on low speed for about 1 minute; add shortening, mix for 1 minutes on low speed; add a half of water, mix for 1 min at low speed; add the rest of water mix for 1 min at low speed; add soy oil mix for 2 minutes on low speed and for 3-4 minutes on high speed.

While the present invention is described with respect to particular examples and preferred embodiments, it is understood that the present invention is not limited to these examples and embodiments. In particular, the present invention is not limited to the ingredients or toppings listed herein so long as the dough has both a SALP and yeast. Moreover, the present invention is not limited to the processing steps recited herein and may contain additional steps, such as mixing steps, as would be apparent to those skilled in the art depending on what ingredients are used.

The present invention as claimed therefore, includes variations from the particular examples and preferred embodiments described herein, as will be apparent to one of skill in the art.

1. Frozen, non-sheeted, non-laminated dough, comprising
flour;
water;
chemical leavening system having one acid ingredient such that no significant carbon dioxide is produced during frozen storage of the dough, wherein the soda ingredient is present in an amount of 0.4% to 1.5% by weight of the flour; and
yeast in an amount equivalent to cream yeast between 3% to 6% by weight of the flour;
wherein the frozen dough does not require proofing.

2. The frozen dough of claim 1, wherein the acid ingredient is sodium aluminum phosphate (SALP).

3. The frozen dough of claim 1, wherein the yeast is present in an amount equivalent to cream yeast of 4% by weight of the flour.

4. The frozen dough of claim 1, wherein the soda ingredient is sodium bicarbonate.

5. The frozen dough of claim 1, wherein the soda ingredient is present in an amount of about 1.3% by weight of the flour.

6. The frozen dough of claim 1, wherein the flour is high gluten flour.

7. The frozen dough of claim 1, further comprising at least one ingredient selected from the group consisting of iron, calcium sulfate, salt, flavored oils, an enzyme, sugar, niacin, a fat source, riboflavin, oil, L-cysteine, thiamine mononitrate, dough conditioner and a flavoring.

8. The frozen dough of claim 7, wherein the fat source comprises vegetable shortening.

9. The frozen dough of claim 7, wherein the flavoring is selected from the group consisting of oregano, basil, garlic, pepper, honey, sesame, cheese, cinnamon, wheat oats, peppers, onions, salsa based flavors, tomatoes and a combination thereof.

10. The frozen dough of claim 1, wherein the dough is shaped into the form of a square.

11. The frozen dough of claim 1, wherein the dough is shaped into the form of a roll, or a bread.

12. Frozen, non-sheeted, non-laminated dough, comprising
flour;
water in an amount of about 45% to about 70% by weight of the total amount of flour;
a chemical leavening system including one soda ingredient in an amount of about 0.4% to about 1.5% and sodium aluminum phosphate in an amount of about 0.4% to about 1.5% by weight of the total amount of flour;
yeast in an amount equivalent to cream yeast of about 3% to about 6% by weight of the flour;
salt in an amount of about 1% to about 3% by weight of the flour;
a stabilizer in an amount of about 0.2% to about 0.5% by weight of the flour; and
vegetable shortening in an amount of about 9% to about 12% by weight of the flour;
wherein the frozen dough does not require proofing and wherein no significant amount of gas is produced during storage of the dough at freezer temperatures.

13. The frozen non-sheeted, non-laminated dough of claim 12, further comprising at least one ingredient selected from the group consisting of iron, ascorbic acid, flavored oils, an enzyme, niacin, riboflavin, oil, corn meal, thiamine mononitrate, flavoring and dough conditioners.

14. The frozen, non-sheeted, non-laminated dough of claim 12, wherein the soda ingredient of the chemical leavening system is sodium bicarbonate.

15. The frozen non-sheeted, non-laminated dough of claim 12, wherein
the flour is high gluten flour;
water is in an amount of about 58% by weight of the flour;
baking soda is in an amount of about 1.3% by weight of the flour;
cream yeast is in an amount of about 5% by weight of the flour;
salt is in an amount of about 1% by weight of the flour;
a stabilizer is in an amount of about 0.33% by weight of the flour; and
vegetable shortening is in an amount of about 9% by weight of the flour;
wherein the frozen dough does not require proofing and wherein no significant amount of gas is produced during storage of the dough at freezer temperatures.

16. A method of making frozen dough, comprising
providing flour, water, one or more soda ingredients in a total amount of about 0.4% to about 1.5% by weight of the flour, one acid ingredient such that no significant gas will be generated when the dough is frozen, and yeast in an amount equivalent to cream yeast of about 3% to about 6% by weight of the flour;
mixing the dry ingredients for about 1 minute on a first speed, adding wet ingredients and mixing about 2 to about 4 minutes on the first speed and then for about 7 to about 19 minutes on a second speed that is faster than the first speed;
adding yeast and mixing for 1 minute on a first speed and for 2 minutes on a second speed; wherein the mixing takes place at a temperature of about 58° to about 64° F.;
shaping the dough to form a shaped dough; and
freezing the shaped dough.

17. The method of claim 16, wherein one component of the chemical leavening system is added just prior to shaping the dough and the dough is further mixed for 2 minutes.

18. The method of claim 16, wherein the yeast is in an amount equivalent to cream yeast of about 4% by weight of the flour.

19. The method of claim 16, wherein the soda ingredient is sodium bicarbonate.

20. The method of claim 16, wherein the soda ingredient is present in an amount of about 1.3% by weight of the flour.

21. The method of claim 16, wherein the flour comprises high gluten flour.

22. The method of claim 16, wherein the ingredients further include one or more ingredients selected from the group consisting of iron, salt, monoglycerides, flavored oils, enzymes, sugar, niacin, fat source, dough conditioner, stabilizer, riboflavin, oil, corn meal, thiamine mononitrate and flavoring.

23. The method of claim 22, wherein the stabilizer is a diacetyl tartaric acid ester of monoglycerides.

24. The method of claim 22, wherein the fat source is vegetable shortening.

25. The method of claim 22, wherein the flavoring is selected from the group consisting of oregano, basil, garlic, pepper, honey, sesame, cheese, cinnamon, wheat oats, peppers, onions, salsa based flavors, tomatoes and a combination thereof.

26. The method of claim 16, wherein the shaping comprises molding and forming the dough into the form of dinner rolls and breads.
